(19) United States
(12) Patent Application Publication
(10) Pub. No.: US 2017/0341780 A1
(43) Pub. Date: Nov. 30, 2017

(54) Negative frame dragging propulsion system

(71) Applicant: Jason Everett Cole, Harper Woods, MI (US)

(72) Inventor: Jason Everett Cole, Harper Woods, MI (US)

(73) Assignee: Warped Dynamics, LLC, Harper Woods, MI (US)

(21) Appl. No.: 14/999,574

(22) Filed: May 27, 2016

(51) Int. Cl. B64G 1/40; B64G 1/26; B64C 39/00

(52) U.S. Cl. CPC B64G 1/409; B64G 1/26; B64C 39/001

(57) ABSTRACT

The invention is based on using a spinning a negative geometry hyperboloid structure to generate negative frame dragging to produce anti gravity effects for propulsion applications. It is theorized that the shape of negative mass on the quantum and Relativistic scale is hyperboloid in shape like our positive matter is made of spherical point particles or spherical planet or star geometry. Rather than using a sphere for frame dragging what if a hyperboloid was used? The idea is that the negative geometry of the spinning hyperboloid would produce a negative frame dragging effect. It is this negative frame dragging using a spinning hyperboloid that leads to anti gravity effects.

### BRIEF DESCRIPTION OF INVENTION

The background of the invention is in aerospace propulsion systems.

Just as spherical mass produces a frame dragging gravitomagnetic effect the idea is to use a hyperboloid that represents the shape of negative mass. It is analogous to negative energy or negative frequency electromagnetism. The idea is to generate a negative warp effect on the surrounding space for a anti gravity propulsion. Creating hill rather than valley of space curvature. It is theorized that the shape of negative mass on the quantum and Relativistic scale is hyperboloid in shape like our positive matter is made of spherical point particles or spherical planet or star geometry.

Earlier attempts with Gravito magnetism used superconductor rotating disc. The overall issue in my view is that any gravito magnetic effect still produces gravity. It's not producing any new outside the ordinary field. It is the same as generating regular electromagnetism. By using a spinning hyperboloid that represents negative mass the goal of the experiment is aimed for negative frame dragging. The effect is analogous to negative energy (negative energy photons) electromagnetism. It will generate a negative warpage of space around it we would perceive as negative momentum or anti gravity.

### DETAIL DESCRIPTION OF INVENTION

The first studied the frame dragging effect around spherical mass objects such as the planet earth. NASAL gravity Beach probe measured frame dragging effects of earth

The Tipler cylinder. Wikipedia described it as follows The Tipler cylinder was discovered as a solution to the equations of general relativity by Willem Jacob van Stockum[1] in 1936 and Kornel Lanczos[2] in 1924, but not recognized as allowing closed timelike curves[3] until an analysis by Frank Tipler[4] in 1974. Tipler showed in his 1974 paper, “Rotating Cylinders and the Possibility of Global Causality Violation” that in a spacetime containing a massive, infinitely long cylinder which was spinning along its longitudinal axis, the cylinder should create a frame-dragging effect. This frame-dragging effect warps spacetime in such a way that the light cones of objects in the cylinder's proximity become tilted, so that part of the light cone then points backwards along the time axis on a space time diagram. Therefore, a spacecraft accelerating sufficiently in the appropriate direction can travel backwards through time along a closed timelike curve or CTC.

The Hyperboloid frame dragging model represents the shape of negative mass and how it rotates to drag space in a reverse vortex flow. Assuming the hyperboloid is hollow it will drag space on its outer curves but also in its interior like a tornado. This approach is based on rotational hyperboloid for the possibility of generating negative kinetic energy frame dragging effects for anti gravity propulsion. The shape of the hyperboloid used for the negative frame dragging effect because it is believed to be the shape of negative mass like spherical point particles make up positive mass. The sphere represents positive mass frame dragging and Hyperboloid represents negative mass frame dragging. The physical interpretation of the cylinder in the Tipler Cylinder is unknown because it don't correspond to positive nor negative mass frame dragging

Wikipedia describes frame dragging as follows:

“Frame dragging is a theory which says that space is elastic, and particles in it will exchange energy with it. In the scientific world, “elastic” means that when you apply a certain amount of force to an object (which will cause it to bend) and then remove the force, the object will return to its original shape and energy state.”

Frame dragging has been used for spherical objects. Einstein's description of frame dragging deals with positive space curved geometry. The theory behind negative frame dragging technology is that the spinning hyperboloid which is believed to be the shape of negative mass. The energy exchange between a rotating sphere and the surrounding space can be thought of as a exchange of positive energy. For a spinning hyperboloid with its negative geometry it can be viewed as exchanging negative energy with the surrounding space. That emission of negative energy into the surrounding geometry is what produces the anti gravity effects and negative electromagnetic radiation effects for mass or EM radiation within the negative frame dragging region.

To generate negative frame dragging for anti gravity effect we simply rotate a hyperboloid. Einstein's frame dragging is based on a spherical rotating object dragging space. If we change the source of the dragging into a negative geometry surface then it will drag space in a negative wave.

To put the sphere and hyperboloid frame dragging into perspective compare it to positive electromagnetic radiation to negative energy (negative photons, negative frequency) electromagnetic radiation.

Any spinning hyperboloid should make negative frame dragging. A key benefit between spherical and hyperboloid frame dragging is that the laws of physics are not the same. We live in a positively curved universe and to generate a little frame dragging we need massive stars. What makes hyperboloid frame dragging so unique and special is that we don't need massive rotating hyperboloid. The negative frame dragging effect is so foreign or outside of our normal laws of physics for a positively curved universe we just need a small negative frame dragging amount for propulsion. By not having a massive spinning hyperboloid reduces the negative time distortion and negative kinetic gravity effects. Negative gravity is repulsive to positive msss. If we had a massive spinning hyperboloid to generate a negative gravity opposite of earth's gravity then it will actually push everything away in earth's gravity strength. Also the spinning hyperboloid will fly apart because the repulsive gravity is trying to repel everything rather than attract. Do to the repulsion and bizarre time dilations around a rotating hyperboloid it's need optimal in a technological sense to want massive high anti gravity distortions from a spinning hyperboloid.

For negative spinning hyperboloid the concept of density and mass and how it warp space is different for spherical rotating mass. To complicate things we are using a spinning hyperboloid made of positive mass to produce a negative frame dragging effect.

When you measure the rate of time based on how fast it is rotating and its geometry deflection it is opposite for sphere and hyperboloid. That leads to the idea that all other physics associated with frame dragging are reverse between the two. If Gravitomagnetism is a widely used term referring specifically to the kinetic effects of gravity, in analogy to the magnetic effects of moving electric charge then negative geometry Gravitomagnetism refer to the “negative kinetic energy of gravity”.

The spinning hyperboloid can be charged or uncharged. The advantage of a spinning charge hyperboloid is that as the electric field move it will generate a electromagnetic field within the vicinity of the negative frame dragging region of the hyperboloid and cause the electromagnetic radiation to take on negative energy electromagnetic physics properties.

When mounted inside a craft such as a flying saucer the spinning hyperboloid can be placed in the center to be the source of negative frame dragging to enable the craft to operate in a negative kinetic region of space geometry.

What makes the co-rotation around a spinning hyperboloid mass so interesting is that the surrounding spherical mass must take on the rotational properties of the central spinning hyperboloid. In this relationship the surrounding objects are under the influence of kinetic energy gravity. It is this mismatch of the negative frame dragging of the spinning hyperboloid and the surrounding positive mass or energy that gives rise to the exotic anti-gravity propulsion.

This new type of Warp Drive is a negative frame dragging propulsion system. Creating a region of negative warp space-time curvature were the laws of physics operate in reverse. The negative Warp Drive takes advantage of the manifestation of these negative physics laws within the negative frame dragging region for new propulsion applications.

### FIGURES

FIG. 1 side view of propulsion system

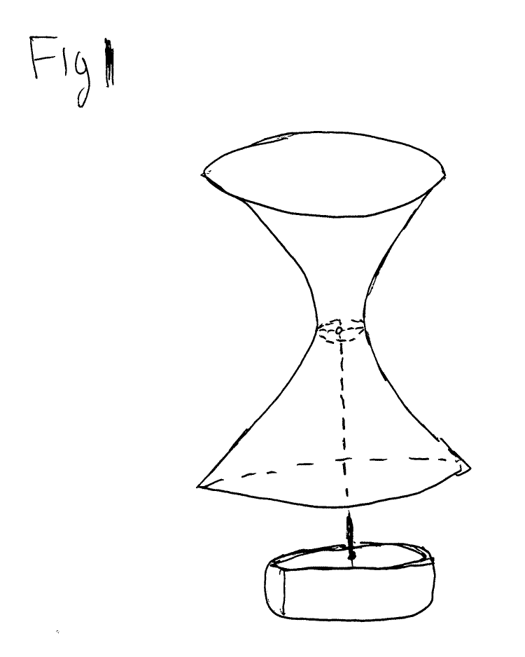

FIG. 2 side view of propulsion system and disc aircraft

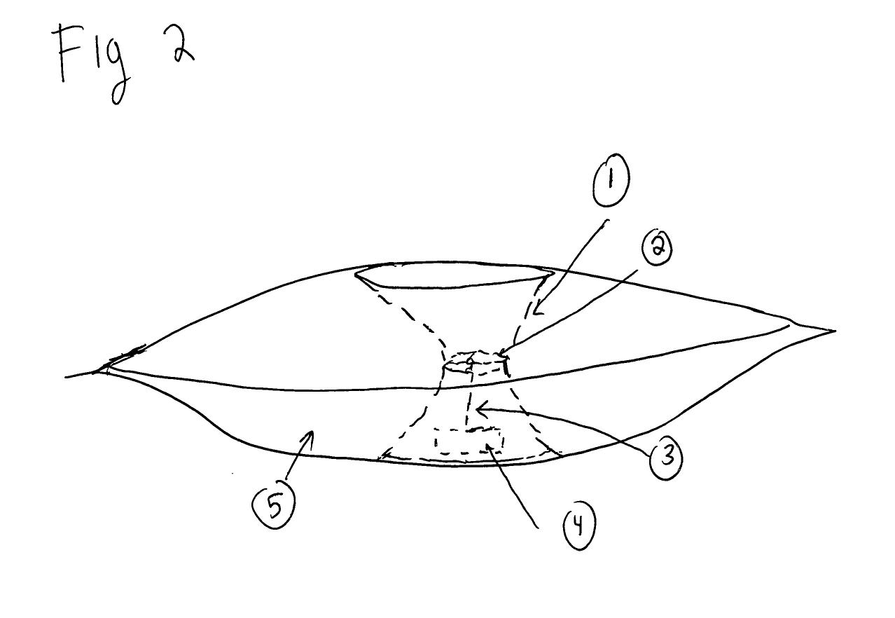

FIG. 3 top view of propulsion system and disc aircraft

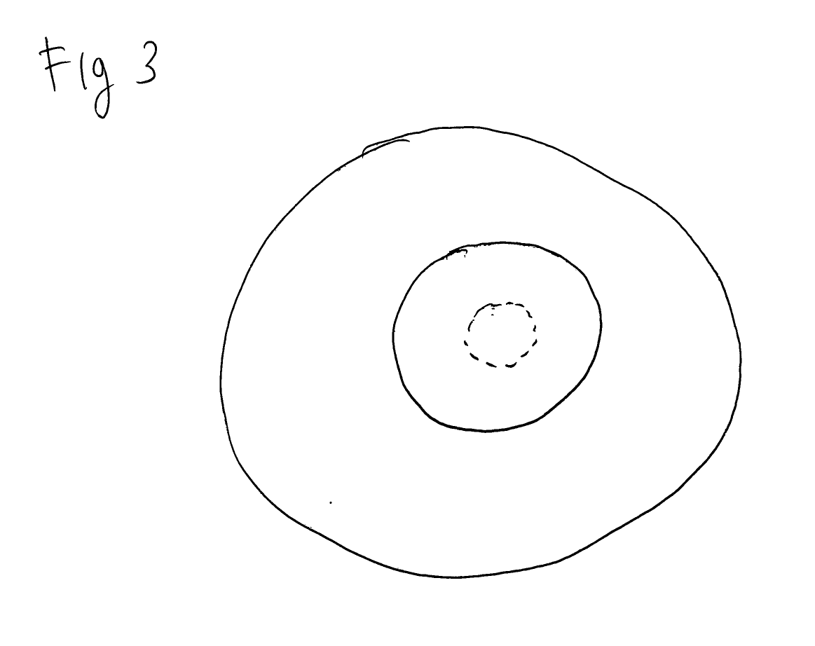

### DESCRIPTION OF DRAWINGS

1. Hyperboloid structure

2. Rim connected the shaft to the hyperboloid

3. Shaft from the electric motor to the flywheel inside the throat of the hyperboloid

4. Electric motor

5. Flying saucer disc fuselage

I claim:

1. A propulsion system comprising:
A spinning hyperboloid or negative geometry structure to generate negative frame dragging for anti-gravity were the spinning hyperboloid is spun by an electric motor via a shaft or spun using external electromagnets or superconductor or spun using air or any other type of method to spin it and the power that drives the spin can come from any power source.
The claim of 1 the spinning hyperboloid or negative geometry structure can spin clockwise or counterclockwise
The claim of 1 the spinning hyperboloids or negative geometry structures can spin in a coaxial or tandem configuration
The claim of 1 the spinning hyperboloid can spin clockwise or counterclockwise to a rotating sphere in a coaxial or tandem configuration
The claim of 1 the spinning hyperboloids or negative geometry structure can be charged or uncharged
The claim of 1 a series of electromagnets or thrusters or jets or rockets or propellers can be placed around the spinning hyperbolic to give it controlled directional propulsion
The claimed of 1 a particle accelerator chamber inside the hyperboloid frame dragging area will produce only negative mass particles
